(19) United States
(12) Patent Application Publication
(10) Pub. No.: US 2008/0063822 A1
(43) Pub. Date: Mar. 13, 2008

(54) Method Of Producing Plastic Containers Comprising An Opening Having A Smaller Diameter Than That Of The Base, And Container Thus Produced

(76) Inventor: Manuel Iglesias Rodriguez, Buenos Aires (AR)

Correspondence Address: ALBERT BORDAS, P.A., 5975 SUNSET DRIVE, SUITE 607, MIAMI, FL, 33143, US

(21) Appl. No.: 11/569,322

(22) PCT Filed: May 9, 2005
(86) PCT No.: PCT/ES05/70060

§ 371 Date: Dec. 7, 2006

(30) Foreign Application Priority Data
May 17, 2004 (AR) P040101705

(51) Int. Cl. B65D 8/20; B29C 45/00

(52) U.S. Cl. 428/35.7; 264/445

(57) ABSTRACT

A method of producing plastic containers comprising an opening having a smaller diameter than that of the base, and the container thus produced, comprising the steps of producing a lower portion and an upper portion of a container separately, using a resin injection process, and welding the lower and upper portions using a hot plate process. The resulting container comprises an opening having a first diameter that is smaller than a second diameter of the base or a longest linear dimension of the base. The lower portion and the upper portion are connected to each other along peripheral edges by means of a weld seam. The lower portion and the upper portion each comprise straight peripheral socketing edges comprising two surfaces which form a right angle and which define an edge at the intersection thereof.

### OTHER RELATED APPLICATIONS

The present application is being filed as a PCT National Phase application in the United States of America, for International Application No. PCT/ES2005/070060, filed on May 9, 2005, which in turn claims priority over Patent No. P040101705 filed in Argentina on May 17, 2004. Both are hereby incorporated by reference.

### BACKGROUND OF THE INVENTION

1. Field of the Invention

The present invention relates to a method of producing containers, and more particularly, to a method of producing plastic containers comprising an opening having a smaller diameter than that of the base, and the container thus produced.

2. Description of the Related Art

As is known in prior art, there are only two methods of manufacturing plastic containers that comprise an opening having a smaller diameter than that of the base. These methods are blow molding and injection blow molding. These methods are typically utilized to develop containers for the chemical and petrochemical industries. As an example, these types of containers are used specifically for containing lubricating oils, agrochemical products, and cosmetics such as creams.

Blow molding is defined as a method of fabrication in which a warm plastic parison (hollow tube) is placed between the two halves of a mold (cavity) and forced to assume the shape of that mold cavity by the use of air pressure. Injection blow molding is defined as a blow molding process in which the parison to be blown is formed by injection molding.

In both methods, plastic material is stretched to take the shape and dimensions of a predetermined container shape and then cooled. Either of the above-mentioned methods may be utilized to manufacture one-piece containers that have effective properties and characteristics for the chemical and petrochemical industries including chemical resistance.

However, a limitation of these methods, is that they produce one-piece containers having rounded external edges. This is because during either method described above, the molecular weight of resins utilized in the art do not allow for plastic material to effectively stretch within certain areas of the matrix, and specifically, internal surfaces of the matrix where two perpendicular walls meet. Consequently, it is difficult to effectively stack and/or pile the one-piece containers having rounded external edges without having them fall. Other disadvantages of these types of containers include inefficient transportation and storage. Another disadvantage of the above-mentioned methods, is the variable wall thickness of the containers developed during the blowing process, because of the fact that the plastic material used does not stretch homogeneously. Yet another disadvantage of the above-mentioned methods, is that they produce a rough external container surface making it difficult to place identifying marks, including decorative illustrations thereon and/or labels.

Applicant believes that one of the closest references corresponds to U.S. Patent Application Publication No. 2002/0020703, published on Feb. 21, 2002 to Kazuyuki Takiguchi, for a plastic container and method for producing the same. However, it differs from the present invention because Takiguchi teaches a plastic container that is constituted by upper and lower tank members and a filter. The filter has a cylinder portion, upper and lower flanges fixed to both ends of the cylinder portion respectively. The upper flange of the filter has a cylindrical flange portion engaged with inner surfaces of butt portions of the upper and lower tank members. Further, a clamped portion is formed on an outer periphery of the cylindrical flange portion and is clamped by the butt portions. The upper and lower tank members are fixedly connected by a plastic band, which is formed by executing an injection welding on an outer peripheral portion including the butt portions and the clamped portion.

Applicant believes that another reference corresponds to U.S. Patent Application Publication No. 2004/0091565, published on May 13, 2004 to Matthew A. Crider, for a blow-molded container and closure, and method and apparatus for making same. However, it differs from the present invention because Crider teaches a blow-molded plastic container and reinforced lid that are simultaneously produced in a blow mold. A lid is reinforced by having a portion of the lid formed by blow molding techniques and another portion of the lid formed by compression molding techniques. The container and lid combination, a method for making the combination and apparatus for making the combination are provided.

Applicant believes that another reference corresponds to U.S. Pat. No. 5,544,777 issued to Watson on Aug. 13, 1996 for a stackable plastic container with drain sump and pallet and method of making the same. However, it differs from the present invention because Watson teaches a plastic container is formed with a body having an access hole on top and a pallet coupled to the bottom thereof. The body also includes a sloping bottom with a sump aligned with the access hole to allow, substantially, all the contents of the container to be removed without turning the body upside down with said pallet protecting the bottom, allowing the container to stand horizontally, and facilitating the stacking of said containers.

Applicant believes that another reference corresponds to U.S. Pat. No. 6,246,777 issued to Agarwal, et al. on Jun. 12, 2001 for a compression-tolerant watermarking scheme for image authentication. However, it differs from the present invention because Agarwal, et al. teaches a verification system for still images that embeds a watermark so that no visual artifacts are created in the images and thus maintains the visual quality of the image. The algorithm embeds information in an uncompressed image so as to later detect the alteration of the image, as well as the location of the alteration. The embedding of information into a source image is based on a defined mapping process. An image plane consists of macro-blocks, which are themselves comprised of micro-blocks. A code is embedded corresponding to the value of this image property in each macro-block. The specific sequence of micro-blocks used for embedding this information in the watermarking image plane is a unique function of this property for the corresponding set of micro-blocks in the indexing image plane. This information can be later decoded from the stamped image. The watermark is embedded by combining the pixel values of the image with the watermark. The watermark is altered if the image is altered.

Other patents describing the closest subject matter provide for a number of more or less complicated features that fail to solve the problem in an efficient and economical way. None of these patents suggest the novel features of the present invention.

### SUMMARY OF THE INVENTION

The instant invention solves the above-mentioned disadvantages of the containers that comprise an opening having a smaller diameter than that of the base, that are manufactured with the blow molding or injection blow molding process.

The instant invention, defining a method of producing plastic containers, produces containers having non-rounded external edges, whereby plastic materials effectively stretch within the matrix, and specifically the internal surfaces of the matrix where two perpendicular walls meet. This method of producing plastic containers allows effective stacking and/or piling the manufactured one-piece containers, thus reducing the probabilities that they will fall or topple over.

Another advantage of the present method of producing plastic containers is efficient transportation and storage. Another advantage of the present method of producing plastic containers is a consistent wall thickness of the containers, whereby the plastic material used, stretches more homogeneously, thus establishing effective resistance to compression. Yet another advantage of the present method of producing plastic containers is that it produces a smooth external container surface making it easy to place identifying marks, including decorative illustrations thereon and/or labels.

The method of producing plastic containers comprising an opening having a smaller diameter than that of the base, comprises the steps of:

A) producing a lower portion and an upper portion of a container separately, using a resin injection process, and

B) welding said lower and upper portions using a hot plate process.

The container thus produced, comprises an opening having a first diameter that is smaller than a second diameter of said base or a longest linear dimension of said base, and a lower portion or body and an upper portion or lid which are connected to each other along the peripheral edges thereof by means of a weld seam. Moreover, the lower portion or body and the upper portion or lid are each equipped with straight peripheral socketing edges comprising two surfaces which form a right angle and which define an edge at the intersection thereof.

The instant invention is also characterized in that the injecting of the lower and the upper portions is completed using the process of thermo-shaping and injection of the resin, and that the welding of the lower and the upper portions is completed using an ultrasound, high frequency, or spin welder process.

It is therefore one of the main objects of the present invention to provide a method of producing plastic containers that have non-rounded external edges to meet required characteristics for transport and storage.

It is another object of this invention to provide a method of producing plastic containers that have consistent wall thickness, whereby the plastic material used stretches more homogeneously, establishing effective resistance to compression.

It is another object of this invention to provide a method of producing plastic containers having a smooth external container surface making it easy to place identifying marks, including decorative illustrations thereon and/or labels.

It is another object of this invention to provide a method of producing plastic containers comprising an opening having a smaller diameter than that of the base.

It is yet another object of this invention to provide such a method that is inexpensive to implement and maintain while retaining its effectiveness.

Further objects of the invention will be brought out in the following part of the specification, wherein detailed description is for the purpose of fully disclosing the invention without placing limitations thereon.

### BRIEF DESCRIPTION OF THE DRAWINGS

With the above and other related objects in view, the invention consists in the details of construction and combination of parts as will be more fully understood from the following description, when read in conjunction with the accompanying drawings in which:

FIG. 1 is a schematic representation of the method for producing plastic containers comprising an opening having a smaller diameter than that of the base.

FIG. 2 is a perspective view of the plastic container produced with the method of the instant invention.

### DETAILED DESCRIPTION OF THE PREFERRED EMBODIMENT

Referring now to the drawings, the instant invention defines the method of producing plastic containers comprising an opening having a smaller diameter than that of the base.

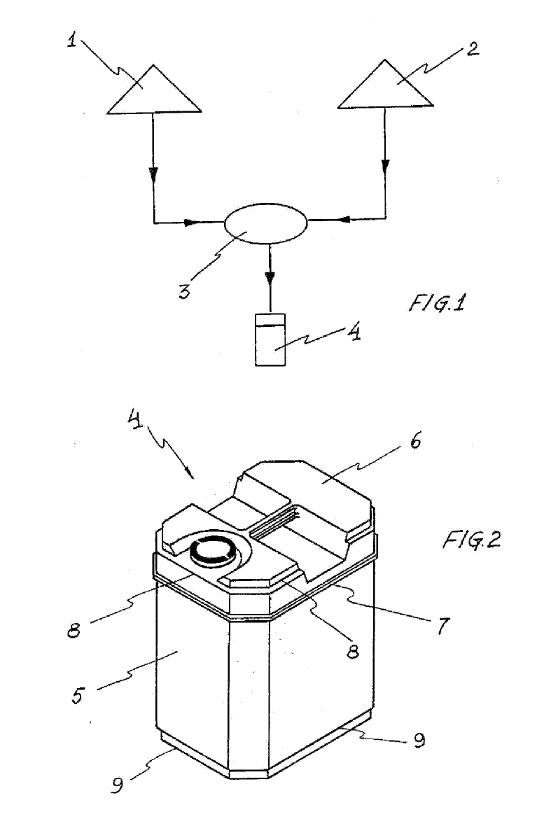

As seen in FIG. 1, the injection of lower portion of container 4 is represented with number 1, while the injection of upper portion or lid of container 4 is represented with number 2. Injection of lower portion 1 and injection of upper portion 2 conform step “A” of the process; producing a lower portion and an upper portion of a container separately, using a resin injection process.

Then, lower and upper portions previously defined, are welded together by a hot plate process. This operation of welding, is represented with number 3, and conform the step “B” of the process; welding said lower and upper portions using a hot plate process. After step “B” is completed, the plastic container 4 is completed.

Therefore, the method of producing plastic containers comprising an opening having a smaller diameter than that of the base, comprises the steps of:

A) producing a lower portion and an upper portion of a container separately, using a resin injection process, and

B) welding said lower and upper portions using a hot plate process.

FIG. 2 shows container 4 as completed with the instant method. Container 4 has a prismatic shape with an opening having a diameter, which is smaller than the diameter or the longest linear dimension of the base. According to the present method, container 4 has lower portion or body 5 and upper portion or lid 6. As described, lower portion or body 5 and upper portion or lid 6 are conformed according to step “A”, and welding along seam 7 is conformed according to step “B”. Outer edges 8 and 9 are straight, allowing the secure stacking and/or piling of a plurality of containers 4. Although not illustrated, it is noted that outer edge 9 is only an edge and defines a cavity of a predetermined depth for lower portion or body 5.

Container 4 thus produced, comprises an opening having a diameter which is smaller than the diameter or the longest linear dimension of outer edge 9, and a lower portion or body 5 and an upper portion or lid 6, which are connected to each other along the peripheral edges thereof by means of a weld seam 7. Moreover, the lower portion or body 5 and the upper portion or lid 6 are each equipped with straight peripheral socketing edges comprising two surfaces which form a right angle and which define an edge at the intersection thereof. When stacking or piling one container 4 upon another, the cavity of the predetermined depth for lower portion or body 5 snaps or mounts onto upper portion or lid 6 of another container 4.

In an alternate embodiment for the method of producing plastic containers comprising an opening having a smaller diameter than that of the base of the present invention, step “A” can be completed using the process of thermo-shaping and injection of resin to conform lower portion or body 5 and upper portion or lid 6, while step “B” can be completed using an ultrasound, high frequency, or spin welder process.

After conforming container 4, it has the same configuration and dimensions of a container conformed by the use of blow or injection blow. However, container 4 has the advantages that lower portion or body 5 and upper portion or lid 6 have joining straight peripheral socketing edges formed by two surfaces at an approximate 90 degree angle, which intersection defines an edge.

The foregoing description conveys the best understanding of the objectives and advantages of the present invention. Different embodiments may be made of the inventive concept of this invention. It is to be understood that all matter disclosed herein is to be interpreted merely as illustrative, and not in a limiting sense.

What is claimed is:

1. A method of producing plastic containers comprising an opening having a smaller diameter than that of the base, and the container thus produced, comprising the steps of:
A) producing a lower portion and an upper portion of a container separately, using a resin injection process, and
B) welding said lower and upper portions using a hot plate process.

2. The method of producing plastic containers comprising an opening having a smaller diameter than that of the base, and the container thus produced set forth in claim 1, further characterized in that a resulting container comprises an opening having a first diameter that is smaller than a second diameter of said base or a longest linear dimension of said base.

3. The method of producing plastic containers comprising an opening having a smaller diameter than that of the base, and the container thus produced set forth in claim 2, further characterized in that said lower portion and said upper portion are connected to each other along peripheral edges by means of a weld seam.

4. The method of producing plastic containers comprising an opening having a smaller diameter than that of the base, and the container thus produced set forth in claim 3, further characterized in that said lower portion and said upper portion each comprise straight peripheral socketing edges comprising two surfaces which form a right angle and which define an edge at the intersection thereof.

5. The method of producing plastic containers comprising an opening having a smaller diameter than that of the base, and the container thus produced set forth in claim 1, further characterized in that said producing said lower portion and said upper portion of said container separately is completed using a process of thermo-shaping and injection of resin.

6. The method of producing plastic containers comprising an opening having a smaller diameter than that of the base, and the container thus produced set forth in claim 5, further characterized in that a resulting container comprises an opening having a first diameter that is smaller than a second diameter of said base or a longest linear dimension of said base.

7. The method of producing plastic containers comprising an opening having a smaller diameter than that of the base, and the container thus produced set forth in claim 6, further characterized in that said lower portion and said upper portion are connected to each other along peripheral edges by means of a weld seam.

8. The method of producing plastic containers comprising an opening having a smaller diameter than that of the base, and the container thus produced set forth in claim 7, further characterized in that said lower portion and said upper portion each comprise straight peripheral socketing edges comprising two surfaces which form a right angle and which define an edge at the intersection thereof.

9. The method of producing plastic containers comprising an opening having a smaller diameter than that of the base, and the container thus produced set forth in claim 1, further characterized in that said welding said lower and upper portions, is completed using an ultrasound process.

10. The method of producing plastic containers comprising an opening having a smaller diameter than that of the base, and the container thus produced set forth in claim 9, further characterized in that a resulting container comprises an opening having a first diameter that is smaller than a second diameter of said base or a longest linear dimension of said base.

11. The method of producing plastic containers comprising an opening having a smaller diameter than that of the base, and the container thus produced set forth in claim 10, further characterized in that said lower portion and said upper portion are connected to each other along peripheral edges by means of a weld seam.

12. The method of producing plastic containers comprising an opening having a smaller diameter than that of the base, and the container thus produced set forth in claim 11, further characterized in that said lower portion and said upper portion each comprise straight peripheral socketing edges comprising two surfaces which form a right angle and which define an edge at the intersection thereof.

13. The method of producing plastic containers comprising an opening having a smaller diameter than that of the base, and the container thus produced set forth in claim 1, further characterized in that said welding said lower and upper portions, is completed using a high frequency process.

14. The method of producing plastic containers comprising an opening having a smaller diameter than that of the base, and the container thus produced set forth in claim 13, further characterized in that a resulting container comprises an opening having a first diameter that is smaller than a second diameter of said base or a longest linear dimension of said base.

15. The method of producing plastic containers comprising an opening having a smaller diameter than that of the base, and the container thus produced set forth in claim 14, further characterized in that said lower portion and said upper portion are connected to each other along peripheral edges by means of a weld seam.

16. The method of producing plastic containers comprising an opening having a smaller diameter than that of the base, and the container thus produced set forth in claim 15, further characterized in that said lower portion and said upper portion each comprise straight peripheral socketing edges comprising two surfaces which form a right angle and which define an edge at the intersection thereof.

17. The method of producing plastic containers comprising an opening having a smaller diameter than that of the base, and the container thus produced set forth in claim 1, further characterized in that said welding said lower and upper portions, is completed using a spin welder process.

18. The method of producing plastic containers comprising an opening having a smaller diameter than that of the base, and the container thus produced set forth in claim 17, further characterized in that a resulting container comprises an opening having a first diameter that is smaller than a second diameter of said base or a longest linear dimension of said base.

19. The method of producing plastic containers comprising an opening having a smaller diameter than that of the base, and the container thus produced set forth in claim 18, further characterized in that said lower portion and said upper portion are connected to each other along peripheral edges by means of a weld seam, said lower portion and said upper portion each comprise straight peripheral socketing edges comprising two surfaces which form a right angle and which define an edge at the intersection thereof.

20. A plastic container, comprising a lower portion having a base and an upper portion having an opening, said upper portion mounts upon said lower portion, said opening having a dimension that is smaller than a longest linear dimension of said base, said lower portion and said upper portion are connected to each other along peripheral edges by means of a weld seam, said lower portion and said upper portion each comprise straight peripheral socketing edges comprising two surfaces which form a right angle and which define an edge at an intersection thereof.
